(19) United States
(12) Patent Application Publication
(10) Pub. No.: US 2013/0284385 A1
(43) Pub. Date: Oct. 31, 2013

(54) Construction for supporting a blind for relatively wide arched windows

(71) Applicants: Dillard Smithers, JR., Trinidad, TX (US); Catherine Smithers, Trinidad, TX (US)

(72) Inventors: Dillard Smithers, JR., Trinidad, TX (US); Catherine Smithers, Trinidad, TX (US)

(21) Appl. No.: 12/928,976

(22) Filed: Dec. 23, 2010

(51) Int. Cl. E06B 9/24

(52) U.S. Cl. CPC E06B 9/24
USPC 160/368.1

(57) ABSTRACT

A construction for use in mounting a blind (earlier called a Venetian blind, in the United States) over a wide window, e.g., a window well in excess of 4 feet, where tying to the foundation is awkward. The construction involves a pair of telescoping tubes that are able to span the full width of the window and are anchored at their ends to the supporting structure (i.e., the foundation of the house or other building) with end brackets. The tubes have enough structural stiffness and resistance to twisting to support the blind (vertically) without requiring any mid-span attachment. Hence, there is no need to tie in to the window frame or any metal as been the case in the past, and the warranty of durability of the window manufacturer is not compromised.

This application claims priority from a Provisional Application Ser. No. 61/284,799, filed Dec. 23, 2009.

### BACKGROUND OF THE INVENTION

1. Field of the Invention

This invention relates generally to windows in buildings, and particularly to supports for window coverings, such as blinds, on the insides of buildings. More particularly, this invention relates to a construction for supporting window blinds that span windows so wide that the blinds, which otherwise would have to be supported in mid-span by the window frame, are supported solely by the building foundation.

2. Description of Related Art

In the building industry it is common for interior decorators to increase the apparent length of a room by installing a blind that extends for the full length of the room—with no interruptions for walls or windows. Such blinds can be installed at the time of the original construction, or at any time during the life of a room. But if a blind is to be installed later in a room's life, and a substantial length is involved, the presence of a window creates a practical problem. In the past, installation of a new blind involved placing a sheet metal screw into the metal frame around the window. But recently the manufacturers of windows were faced with claims for damage when water apparently leaked through a window that had been modified from its original installation by the addition of a weighty blind. They responded to this problem in a reasonable manner—by decreeing that their warranty would be void if it was determined that a supporting screw for a blind had been inserted into the metal frame around the window. This left installation crews with the problem of how to support a blind without interfering with the cosmetic appearance of the blind and not disturbing the overall effect of the installation. That is, the installed blind should be relatively inconspicuous and not protrude too much into the interior of the room.

Another factor that must be taken into account in after-marketing installation of blinds is the fact that a home owner will place his or her order by phone or at a store, and installation will occur at a remote location. The time of installation can often be at a place that a worker has never seen and may have been described incorrectly—with incorrect dimensions, etc. It follows that a worker must be able to make adjustments on the spot, and be able to fit the blind into whatever he finds when he arrives at a home. It is also true that labor costs are often increasing to a point that having two men go out on a job may not be practical—if one man can do the job alone. It is preferable that a single person be capable of installing a blind alone, even if the blind is over, say, eight feet long, which is beyond the span of a normal worker's arms. It follows that there are several considerations that must be kept in mind, all of which must be done without having any communication with the blind manufacturer. The discovery revealed herein discloses a solution to these myriad problems.

The blinds (window covers) are sold under such trademarks as Bali, Halcyon, and Levolor. When similar covers are modestly sized, i.e. 48 inches or less (in width), it is possible to physically support the blinds at each of two ends. But with greater widths there is a risk that too much torque will be introduced into the blinds, and the blinds will twist in an awkward manner—which would totally defeat the purpose of creating an attractive structure. But the appetite for consumers has not diminished, and even wider windows are being offered to consumers that need to be covered.

Another consideration comes into play when a retailer contemplates the warehousing requirements for blinds that may be of an unusual (wide) size and may be required in relatively small quantities. While a contractor may expect to pay somewhat more for a product that is not in great demand, there comes a point where variety in size becomes an essential factor in making stocking decisions. Therefore, it would be advantageous to be able to keep in inventory a blind that could be installed in a window that has a width of, say, 50 to 96 inches or more. While the task of manufacturing such blinds may not be a problem, the installation of extra wide blinds in an attractive manner can become a problem.

Another factor is the timeliness of installation. A retailer who is facing competition from someone else must keep in mind what his competitor is offering. For example, Home Depot, a widely known home-improvement retailer, advertises—in print, “Make one phone call and your blinds are up within 48 hours”. It would be hard to make such an offer if you had to wait for a custom-made blind to be fabricated and installed after multiple trips to a home site.

### SUMMARY OF THE INVENTION

A construction for use in mounting a blind (earlier called a Venetian blind, in the United States) over a wide window, e.g., a window well in excess of 4 feet, where tying to the foundation is awkward. The construction involves a pair of telescoping tubes that are able to span the full width of the window and are anchored at their ends to the supporting structure (i.e. the foundation of the house or other building) with end brackets. The tubes have enough structural stiffness and resistance to twisting to support the blind (vertically) without requiring any mid-span attachment. Hence, there is no need to tie in to the window frame or any metal as has been the case in the past, and the warranty of durability of the window manufacturer is not compromised.

### BRIEF DESCRIPTION OF THE SEVERAL FIGURES OF THE DRAWINGS

FIG. 1 is a perspective view of the two tubular pieces of the construction, said two pieces being joined together, and the smaller piece being inserted partially into the larger piece.

FIGS. 2, 3 and 4 are views of the small bracket 26—before they are anchored to the window sash.

FIGS. 5, 6 and 7 are views of the larger bracket 28 before they are anchored to the window sash, i.e., before they are attached to any support around the window.

FIG. 8 shows the inter-connection of the two tubular pieces 20, prior to their placement next to a window.

FIG. 9 is a fragmentary showing of the assembly of the combination of a factory-supplied bracket 32 over a collar 30.

FIG. 10 shows the two tubular pieces installed adjacent a window, prior to the mounting of a blind.

FIG. 11 shows a blind after it has been installed adjacent a window, said window having what is sometimes described as an “eyebrow” shape.

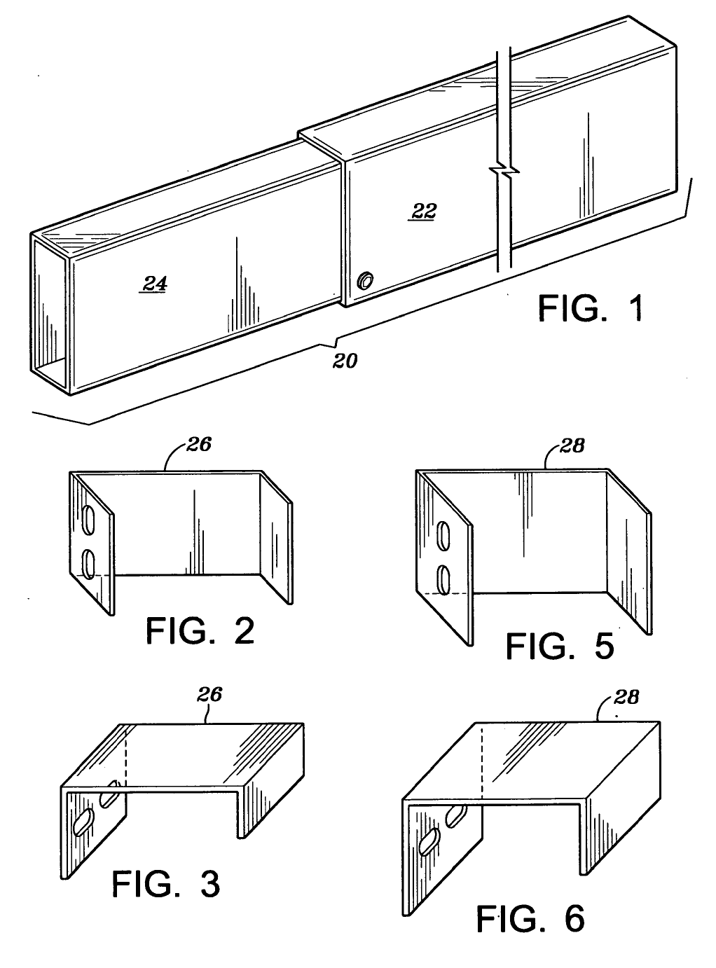

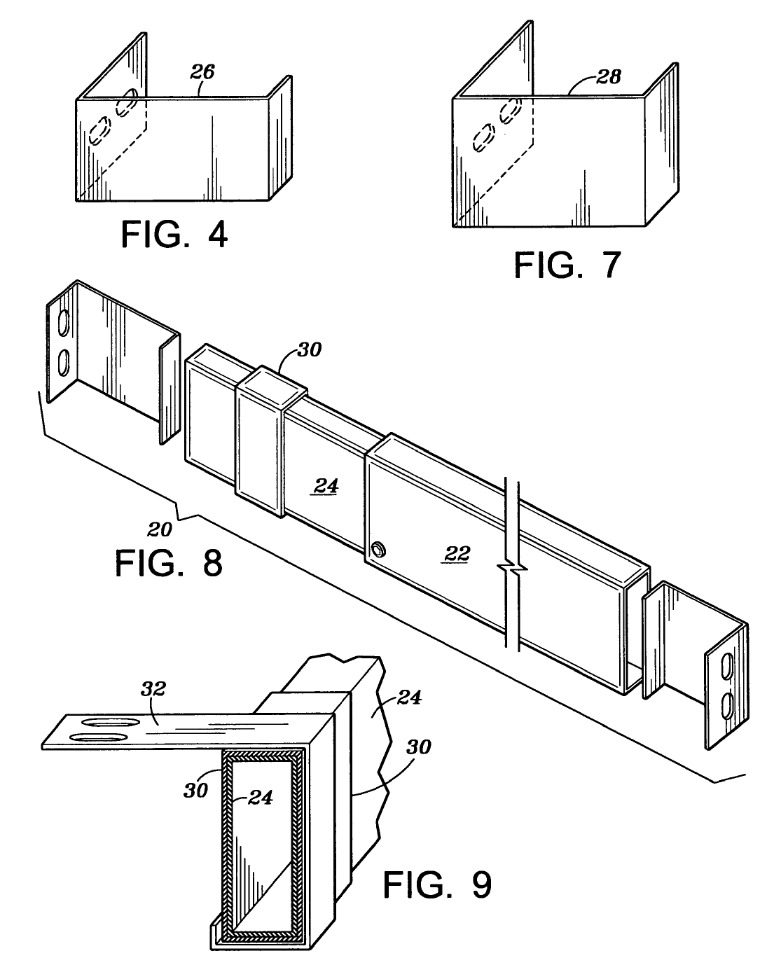

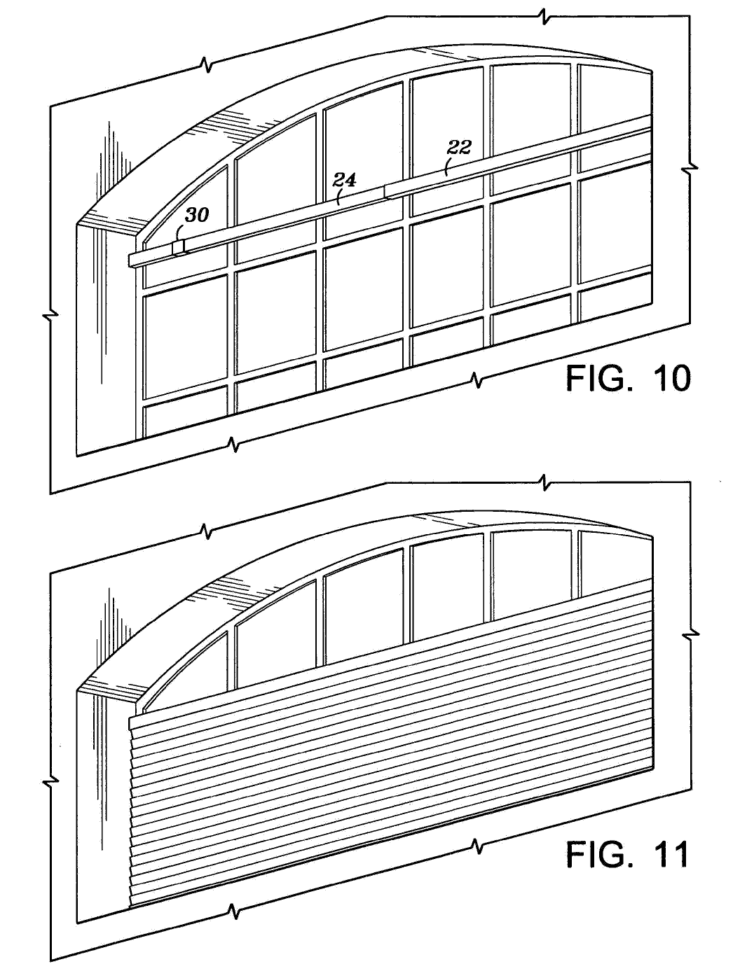

### DESCRIPTION OF A PREFERRED EMBODIMENT

As disclosed in the Provisional Patent Application (Ser. No. 61/284,799), the two principal elements that make up an assembly as disclosed herein are a pair of elongated structural members that are tubular in nature, one being just slightly larger in cross section so that it can be slipped over the other in a telescopic manner. The preferred materials are 16-gauge steel members that are painted a neutral color. The smaller tube 24 has a height of about 1.5 inches, so as to have an adequate moment of inertia. The larger tube 22 has a height of about 1.6 inches, so it will slide just over the smaller tube 24. The length of the larger tube 22 is selected to be about 8 inches greater than the smaller tube 24 so there will be an overlap of about 8 inches in length when the two members 20 are extended to their maximum span. Because the larger of the two tubes 22 is what may be properly called smooth-bored, the larger of the two tubes 22 may be engaged from either of the two ends. When engaged from both ends (by two of the smaller tubes), the assembly 20 can be expanded—to cover an even greater length.

The companion pieces for the tubular pieces are a pair of end brackets 26, 28, one of which is slightly smaller (to mate with the smaller of the two tubes 24) and one of which is slightly larger (to mate with the larger of the two tubes 22). Each of these two brackets 26, 28 has flat base with pre-drilled holes to receive substantial screws. When the structure around the window is made of wood members, the screws will be wood screws; and naturally sheet metal screws will be used when metal framing is around the windows.

Protruding in a direction away from the window sash is an integral piece of a bracket that is designed to engage, in a snug manner, one or the other tubular members that will span the window opening. Of course, these end brackets are normally installed first, and then the tubular members are connected to the end brackets by sliding an end of a tubular member over the outwardly protruding part of the adjacent part of the adjacent bracket.

Once two end brackets and appropriate tubular members are installed, the horizontal position of the blind will have been established. Next, vertical support will have to be established. This is done by the creation of special brackets that are made of steel and shaped like the letter G (and are therefore are conveniently called G brackets 32, to distinguish them from the aforementioned end brackets.) The size of the opening in the G-bracket 32 is appropriate to just slide over (transversely) the exterior of the larger tube 22. Hence, vertical loads can be applied from a blind (not shown) through any one of the nearby G-brackets 32—to the nearby tubular member, and hence to the to the window sash—and to the foundation of the building. All that is required is to transfer the weight of a blind to an appropriate G-bracket 32. The blind manufacturer need only require that an installer use their support bracket 32, which they already supply with each “kit” that they sell. Each blind manufacturer has their own style of bracket 32, but all of them will be compatible with the universal G-bracket 32 described herein. There is also a collar 30 that can be used as a bushing on one of the small tubes 24 if an extra G-bracket 32 is believed to be needed.

Hence, with this construction there is no need to put any vertical loading on an installed window—and the window manufacturer need not be concerned about abuse of his product. In other words, structural loading of the window and an adjacent blind can be independent of one another with this construction, although both ultimately tie back to the building's foundation.

1. A construction for use in mounting a blind adjacent a window in a building, comprising:
a. a pair of elongated tubular members, a smaller one of said pair of elongated tubular members being slightly smaller in cross-sectional area than a larger one of said pair of elongated tubular members and adapted to be inserted at least partially into the larger one of said pair of elongated tubular members in a telescopic manner;
b. a pair of end brackets affixed to opposite ends of the two elongated tubular members, said end brackets being structurally supported by the foundation of the building;
c. at least one a G-bracket adapted to be affixed to the blind in such a way that it can carry the full weight of the blind and transfer that weight to the pair of elongated tubular members, whereby the full weight of the blind will be transferred to the pair of elongated tubular members and hence to the building's foundation.

2. The construction as claimed in claim 1, wherein
a collar is attached to the smaller one of the elongated tubular members in order to expand the combined spatial envelope of the collar and the smaller one of the elongated tubular members, so that the combination matches the spatial envelope of the larger one of the two elongated tubular members.

3. The construction as claimed in claim 1 wherein
the G-bracket can be installed transversely over the larger of the two tubular members, and
said G-bracket is adjustable at will along the length of the tubular member.

4. The construction as claimed in claim 1 wherein
the tubular members are made of cold rolled steel that are welded so as to provide a box-like configuration when examined transversely,
and whereby
resistance to torque loading will be enhanced.

5. A window covering support system for supporting a window covering adjacent a window in a building having a foundation, the window covering support system comprising:
at least one first tubular member, each of said at least one tubular members surrounding and defining a first tubular member interior and having a first tubular cross section and a first tubular length;
at least one second tubular member, each of said at least one second tubular members surrounding and defining a second tubular member interior and having a second tubular length and a second tubular cross section congruent with said first tubular cross section, said each of said at least one second tubular members being adapted to be received telescopically within said first tubular member interior;
a pair of end brackets affixed to opposite ends of the two tubular members, said end brackets being structurally supported by the foundation of the building; and
at least one window covering support bracket disposed along at least one of said first tubular length and said second tubular length and adapted to be affixed to and to support said window covering.

6. The window covering support system of claim 5 wherein each of said pair of end brackets is
coupled to said building adjacent and on opposite sides of said window; and
adapted to be journaled within one of said first tubular interior and said second tubular interior.

7. The window covering support system of claim 5 wherein
a collar surrounds said at least one second elongated tubular member; and
at least one of said at least one window covering support brackets is coupled to said collar and disposed along said at least one second elongated tubular member.

8. The window covering support system of claim 1 wherein each of the end brackets further comprises
a flat bracket base adapted to be affixed to the building;
an outwardly protruding, L-shaped bracket member having
a first bracket member portion coupled by its proximate end to said bracket base and extending substantially perpendicular thereto to its distal end; and
a second bracket member portion coupled to said distal end an extending substantially parallel to said bracket base,
said L-shaped bracket member being adapted to be received within one of said first tubular member interior and said second tubular member interior.

9. The window covering support system of claim 5 wherein
said first tubular cross section and said second tubular cross section comprise generally rectangular, boxed shapes; and
said window covering support bracket
is configured into a generally G-shaped cross section congruent with and adapted to surround and engage one of said first tubular cross section and said second tubular cross section; and
extends perpendicular to said first tubular member and said second tubular member to couple to said window covering.

10. A support system for a window covering disposed adjacent a window in a building having a foundation, the support system comprising:
at least one larger tubular member surrounding and defining a larger tubular member interior and having a larger tubular member cross section and a larger tubular member length;
at least one smaller tubular member surrounding and defining a smaller tubular member interior and having a smaller tubular member cross section congruent with said larger tubular cross section and a smaller tubular member length and adapted to extend telescopically a selected distance into said larger tubular interior;
end brackets coupled to opposite ends of each of the larger and smaller tubular members and structurally supported by the foundation of the building; and
at least one G-bracket disposed along at least one of the larger and the smaller tubular members and adapted to couple the window covering to the support system.

11. The window covering support system of claim 10 and further comprising
a collar is coupled between said smaller tubular member and at least one of said at least one G-brackets.

12. The window covering support system of claim 10 and further comprising
a third tubular member congruent with and journaled with one of said at least one larger tubular member and said smaller tubular member and extending to one of said end brackets.

13. A method of supporting a window covering across a window in a building, the window having a window width, the building having a foundation, the method comprising
providing a window covering support structure having
at least one larger tubular member surrounding and defining a larger tubular member interior and having a larger tubular member cross section and a larger tubular member length;
at least one smaller tubular member surrounding and defining a smaller tubular member interior and having a smaller tubular member cross section congruent with said larger tubular cross section and a smaller tubular member length and adapted to articulate longitudinally and telescopically at least partially within said larger tubular interior;
a pair of end brackets, each one of said pair of end brackets adapted couple to one end of one of said larger and smaller tubular members and to be coupled to the foundation of the building; and
at least one G-bracket disposed along at least one of the larger and the smaller tubular members and adapted to couple the window covering to the support system; then journaling said at least one smaller tubular member telescopically a spaced distance within said larger tubular member interior so that an overall length of said journaled tubular members is less than said width of said window;
affixing each of said pair of end brackets on opposite sides of said window; then
journaling one of said end brackets into one of said larger tubular member interiors and said smaller tubular member interiors; then
extending one of said at least one smaller tubular members coaxially with said at least one larger tubular member to an overall length of said journaled tubular members substantially equivalent to said window width; then
journaling said other one of said pair of end brackets into another one of said larger tubular member interiors and said smaller tubular member interiors; then
coupling said G-bracket to said window covering.

14. The method claim 12 and further comprising
before the affixing step,
journaling said at least one smaller tubular member coaxially within a collar; then affixing said at least one G-bracket to said collar.

15. The method claim 12 and further comprising
providing a third tubular member congruent with one of said at least one larger tubular member and said smaller tubular member;
then, before the affixing step,
telescopically journaling said third tubular member with one of said at least one larger tubular members and said smaller tubular members.
